(19) United States
(12) Patent Application Publication
(10) Pub. No.: US 2016/0288624 A1
(43) Pub. Date: Oct. 6, 2016

(54) AIR VENT FOR A VEHICLE

(71) Applicant: GM GLOBAL TECHNOLOGY OPERATIONS LLC, Detroit, MI (US)

(72) Inventors: Douglas Albin, New Baltimore, MI (US); Ryan F. Vaughan, Troy, MI (US); Dirk Matthias Wexel, Mainz (DE)

(73) Assignee: GM GLOBAL TECHNOLOGY OPERATIONS LLC, Detroit, MI (US)

(21) Appl. No.: 14/991,269

(22) Filed: Jan. 8, 2016

Related U.S. Application Data
(60) Provisional application No. 62/141,539, filed on Apr. 1, 2015.

(51) Int. Cl. B60H 1/34

(52) U.S. Cl. CPC B60H 1/3421; B60H 2001/3471

(57) ABSTRACT

An air vent is disposed between an air circulation device and an interior space is described, and includes a housing defining a first chamber in fluidic communication with a second chamber, wherein the first chamber includes a fluidic inlet in fluidic communication with the air circulation device and the second chamber includes a fluidic outlet in fluidic communication with the interior space. A first airflow control vane is disposed in the first chamber to direct the airflow from the air circulation device in a first direction. A second airflow control vane is disposed in the second chamber to direct the airflow in a second direction that is orthogonal to the first direction. A single operator-directed device is operatively coupled to the first airflow control vane and the second airflow control vane, and is disposed to independently adjust the positions of the first and second airflow control vanes.

### CROSS-REFERENCE TO RELATED APPLICATIONS

This application claims the benefit of U.S. Provisional Application No. 62/141,539, filed Apr. 1, 2015, which is hereby incorporated by reference in its entirety.

### TECHNICAL FIELD

The present disclosure relates to an air vent for a vehicle.

### BACKGROUND

Modern passenger vehicles include a heating, ventilation, and air conditioning (HVAC) system that allows a vehicle occupant to control the temperature or adjust other settings of a vehicle interior. For instance, a motor-driven fan or blower circulates conditioned air to the vehicle interior through air vents. Some vehicles are equipped with heated and/or cooled seats, a heated steering wheel, and other features that collectively improve the overall drive experience. HVAC systems may include front and rear defrosters for improving visibility through the windshield and rear window, respectively. An occupant of the vehicle selects desired HVAC system settings using dials, knobs, push-buttons, and/or touch screens.

### SUMMARY

An air vent disposed between an air circulation device and an interior space is described, wherein the air circulation device is capable of creating an airflow. The air vent includes a housing defining a first chamber in fluidic communication with a second chamber, wherein the first chamber includes a fluidic inlet in fluidic communication with the air circulation device and the second chamber includes a fluidic outlet in fluidic communication with the interior space. A first airflow control vane is disposed in the first chamber and configured to direct the airflow from the air circulation device in a first direction. A second airflow control vane is disposed in the second chamber and configured to direct the airflow in a second direction that is orthogonal to the first direction. A single operator-directed device is operatively coupled to the first airflow control vane and the second airflow control vane. The single operator-directed device is disposed to independently adjust the positions of the first and second airflow control vanes.

The above features and advantages and other features and advantages of the present teachings are readily apparent from the following detailed description of the best modes for carrying out the present teachings when taken in connection with the accompanying drawings.

### BRIEF DESCRIPTION OF THE DRAWINGS

One or more embodiments will now be described, by way of example, with reference to the accompanying drawings, in which:

FIG. 1 illustrates a schematic plan view of an example vehicle having an air vent, in accordance with the disclosure;

FIG. 2 illustrates a perspective view of an example vehicle interior having a center stack containing an embodiment of the air vent of FIG. 1, in accordance with the disclosure;

FIGS. 3-1 and 3-2 schematically show a partial cut-away top view and side view, respectively, of an embodiment of an air vent that employs a single, unitary operator-directed device in the form of a slider mechanism for controlling positions of a first airflow control vane and a plurality of second airflow control vanes, in accordance with the disclosure;

FIGS. 4-1 and 4-2 schematically show a partial cut-away top view and side view, respectively, of an embodiment of an air vent that employs a single, unitary operator-directed device in the form of another embodiment of a joystick mechanism for controlling positions of a first airflow control vane and a plurality of second airflow control vanes, in accordance with the disclosure;

FIG. 5 schematically shows a partial cut-away top view of an embodiment of an air vent that employs a single, unitary operator-directed device in the form of another embodiment of a joystick mechanism for controlling positions of a first airflow control vane and a plurality of second airflow control vanes, in accordance with the disclosure;

FIG. 6 shows a partial cut-away top view of an embodiment of an air vent that employs a single, unitary operator-directed device in the form of another embodiment of a joystick mechanism for controlling positions of a first airflow control vane and a plurality of second airflow control vanes, in accordance with the disclosure;

FIG. 7 schematically shows a partial cut-away isometric view of an embodiment of an air vent that employs a single, unitary operator-directed device in the form of an embodiment of a center pivot joystick for controlling positions of a first airflow control vane and a plurality of second airflow control vanes, in accordance with the disclosure;

FIG. 8 schematically shows a front view of an embodiment of an air vent that employs a single, unitary operator-directed device in the form of a rotatable thumbwheel controlling positions of first airflow control vanes and a plurality of second airflow control vanes, in accordance with the disclosure;

FIGS. 9-1 through 9-5 schematically show one embodiment of the air vent that employs the rotatable thumbwheel for controlling positions of first airflow control vanes and a plurality of second airflow control vanes employing a first bevel gear arrangement to adjust the second airflow control vanes, in accordance with the disclosure;

FIGS. 10-1 through 10-5 schematically show another embodiment of the air vent that employs the rotatable thumbwheel for controlling positions of first airflow control vanes and a plurality of second airflow control vanes employing a second bevel gear arrangement to adjust the second airflow control vanes, in accordance with the disclosure; and

FIGS. 11-1 through 11-3 schematically show an embodiment of the air vent that employs the rotatable thumbwheel for controlling positions of first airflow control vanes and a plurality of second airflow control vanes employing a rack and pinion gear arrangement to adjust the second airflow control vanes, in accordance with the disclosure.

### DETAILED DESCRIPTION

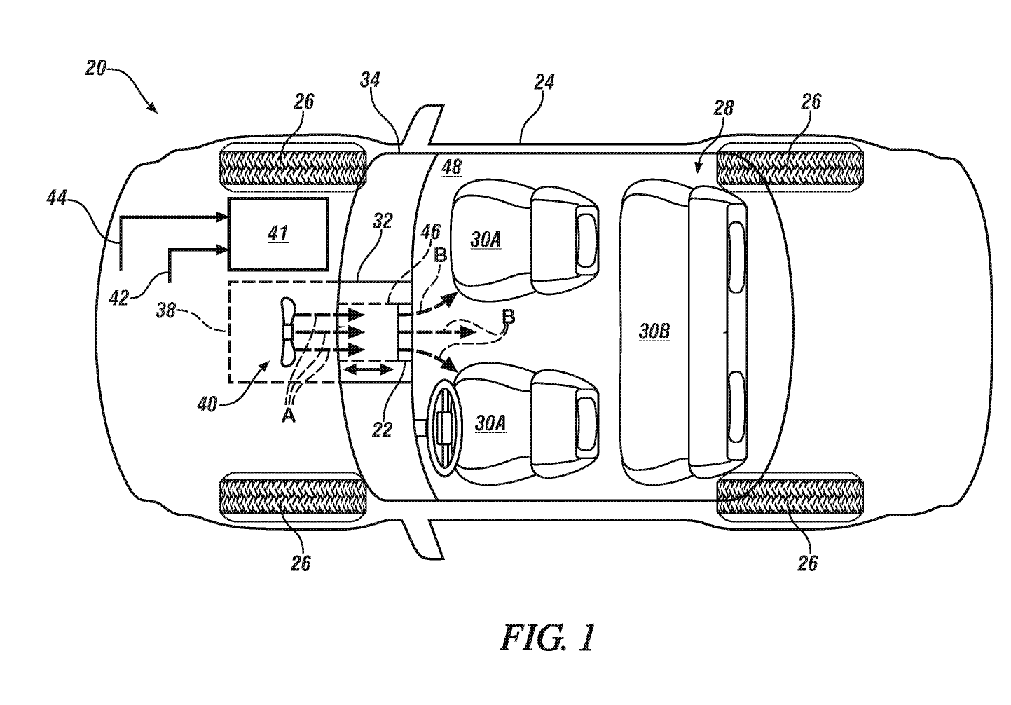

Referring to the drawings, wherein like reference numbers refer to the same or similar components throughout the several views, an example vehicle 20, such as a motor vehicle, is shown in FIG. 1 having an air vent 22 as set forth herein. The vehicle 20 includes a body 24 located with respect to a set of wheels 26, with the body 24 defining an interior space 28, i.e., a passenger compartment or cabin. The interior space 28 depicts respective first and second rows of seats 30A, 30B. The first row of seats 30A may include respective driver-side and passenger-side seats as shown. Other seating configurations may be envisioned, including an embodiment of the interior space having only the first row of seats 30A, or an embodiment of the interior space having an additional row of seats, neither of which is shown. One example of an embodiment of the air vent 22 is depicted in the figures. It should be appreciated that the air vent 22 is not limited to being used in a vehicle 20, as the air vent 22 may be used with other structures or devices, such as, but not limited to, buildings, watercraft, aircraft, electronic devices, and the like. It is appreciated that terms such as “above,” “below,” “upward,” “downward,” “top,” “bottom,” “left,”, “right,” “vertical,” and “horizontal” etc., are used descriptively for the figures, and do not represent limitations on the scope of the disclosure, as defined by the appended claims.

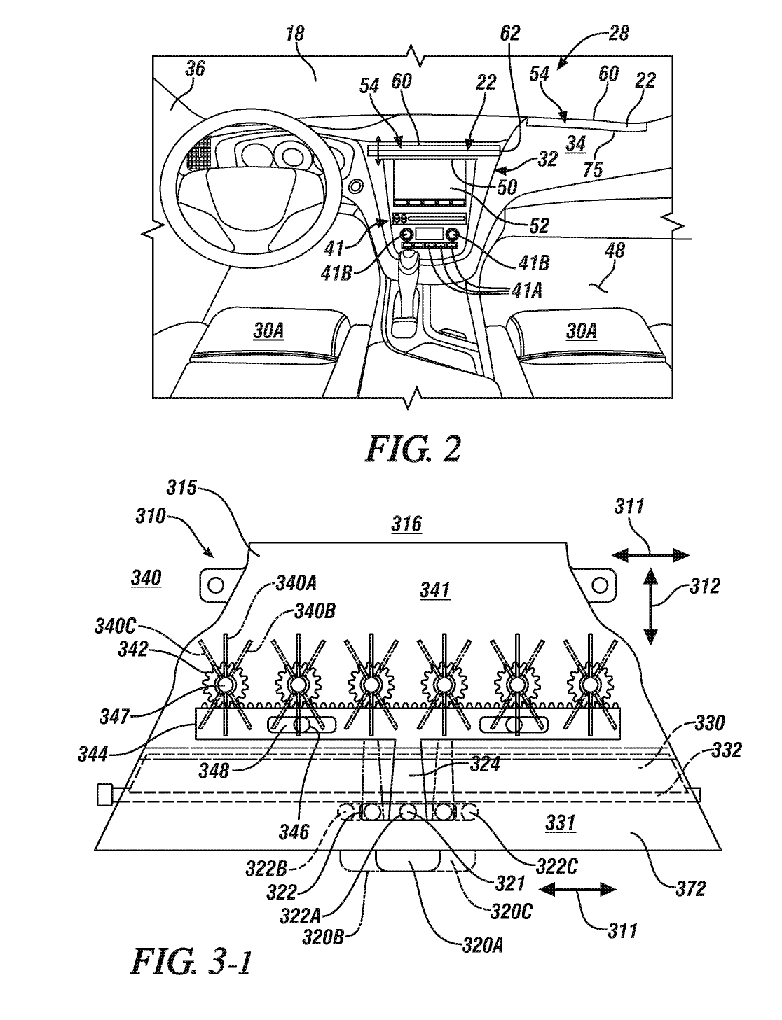

A possible configuration and placement of the air vent 22 is shown in FIG. 2. The air vent 22 of FIG. 1 may be located within a center stack 32 of the interior space 28, adjacent to a dashboard 34. A center stack 32 is a control console located between the driver-side seat and the passenger-side seat, in the first row of seats 30A extending from the dashboard 34 toward a floor 48 of the interior space 28. Alternatively, the air vent 22 may be located elsewhere, including along the dashboard 34, within a vehicle ceiling space (not shown), within one or more roof pillars, e.g., an A-pillar 36, a B-pillar (not shown) between the front row of seats 30A and the rear row of seats 30B, and adjacent the rear row of seats 30B, by way of non-limiting examples. For example, the rear row of seats 30B may be divided into separate seating areas by an arm rest (not shown) or other structure, with the air vent 22 located within or adjacent to such structure.

The air vent 22 is in fluidic communication with a heating, ventilation, and air conditioning (HVAC) system 38 having an air circulation device 40, for instance a motor-driven fan or blower, and a controller 41. The HVAC system 38 receives HVAC control setting signal (arrow 44) from the controller 41 in response to user-selected HVAC settings (arrow 42) from controls 41, such as buttons 41A, knobs 41B, and the like. In response to the received HVAC control setting signal (arrow 44), the HVAC system 38 directs ambient, heated, or cooled airflow (arrows A) into the interior space 28, for instance through a duct 46 and the air vent 22. In embodiments in which the air vent 22 is used in proximity to the rear row of seats 30B, the duct 46 may be extended beyond the front row of seats 30A such that the duct 46 supplies the airflow as indicated by arrows A to the air vent 22 wherever the air vent 22 is situated within the interior space 28. The airflow is directed by the air vent 22 into the vehicle interior space 28 in a desired direction, as indicated by arrow B.

FIG. 2 schematically shows one configuration of the interior space 28 with the air vent 22 shown located within the center stack 32 and visible to the vehicle occupants. The air vent 22 may have an outlet opening 54 having a generally rectangular profile having a pair of opposed first sides 60, extending along a length L, and a pair of opposed second sides 62, extending along a height H, with the aspect ratio being the ratio of the length L to the height H. A high aspect ratio indicates that the length L is significantly greater than the height H. By way of a non-limiting example, a high aspect ratio may be an aspect ratio that is 5:1. However, it should be appreciated that an air vent having a smaller aspect ratio may also be employed, including, but not limited to an aspect ratio of 1:1. The first and second sides 60, 62 cooperate to define the outlet opening 54, through which air exits the air vent 22. The air vent 22 may be disposed within the vehicle 20 to have a very elongated, narrow profile without sacrificing the ability to direct the flow of air (arrow B) in a desired direction within the interior space 28 of the vehicle 20 with a low pressure drop. The air vent 22 is located between a windshield 18 and a main display screen 52, i.e., adjacent to or along a top edge 50 of a main display screen 52, as viewed from the normal forward-looking driving perspective of an operator of the vehicle 20. However, as noted above the air vent 22 may also be located elsewhere in the interior space 28. For example, the air vent 22 may be located in location 75 as shown, which is forward of the passenger seat 30A. Placement of the air vent 22, regardless of the embodiment, may be in sufficiently close proximity to an occupant, whether a driver or a front/rear seat passenger of the vehicle 20 of FIG. 1, such that the occupant can comfortably reach the air vent 22 from a seated position.

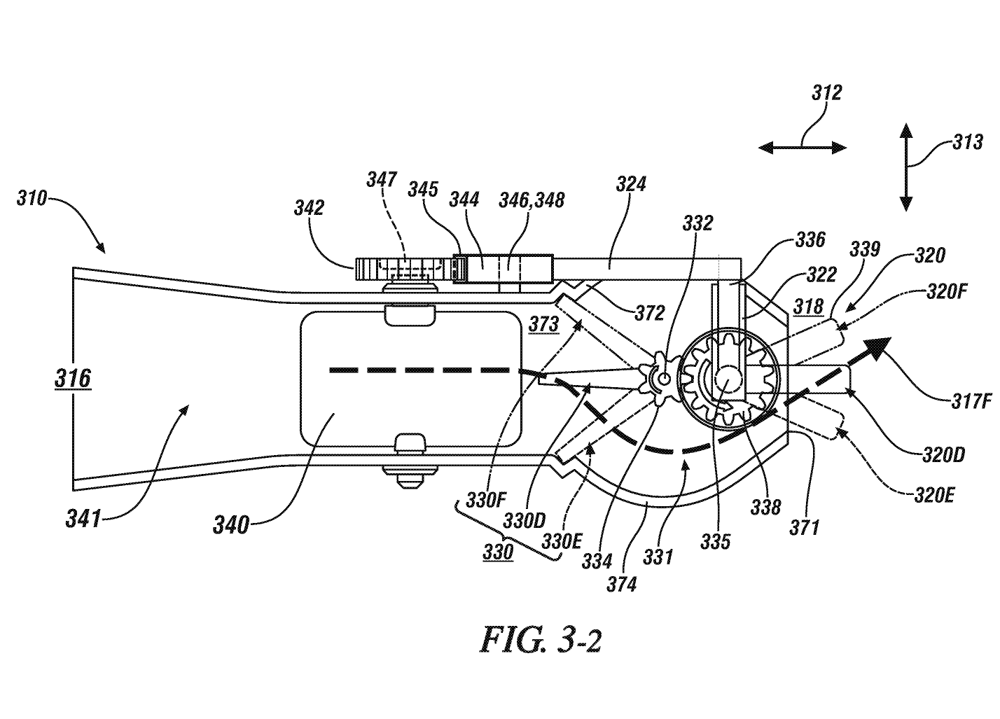

FIGS. 3-1 and 3-2 show a partial cut-away top view and side view, respectively, of an embodiment of a high aspect ratio air vent 310 for an HVAC system that employs a single, unitary operator-directed device 320 for controlling positions of a first airflow control vane 330 and a plurality of second airflow control vanes 340, wherein the operator-directed device 320 may be employed to adjust the position of the first airflow control vane 330 independently from adjusting the positions of the second airflow control vanes 340. As employed herein, the term “vane” and related terms describe planar devices that are configured to deflect or otherwise control airflow. The first airflow control vane 330 directs the airflow supplied at fluidic inlet 316 in a direction that is orthogonal to the airflow directed by the second airflow control vanes 340. In this embodiment, the operator-directed device 320 is a slider mechanism. The top view in FIG. 3-1 is described in context of a lateral axis 311 and a longitudinal axis 312, and the side view of FIG. 3-2 is described in context of the longitudinal axis 312 and an elevation axis 313. The lateral axis 311, longitudinal axis 312 and elevation axis 313 are nominal axes that may relate to corresponding axes in a vehicle, e.g., the vehicle 20 described with reference to FIG. 1.

The air vent 310 may be assembled into a unitary device for assembly into a passenger compartment of the vehicle 20, and includes a housing 315 that is formed to include a first chamber 331 and a second chamber 341. The second chamber 341 is in fluidic communication with the first chamber 331, and airflow received at the fluidic inlet 316 to the air vent 310 passes through the second chamber 341 to the first chamber 331 and then to the fluidic outlet 318 into the passenger compartment. The second chamber 341 preferably has a rectangular cross-section. The first chamber 331 is substantially tubular-shaped with a longitudinal axis that is parallel to the lateral axis 311, and includes a non-linear upper wall section 372 and a non-linear lower wall section 374. The non-linear upper wall section 372 and non-linear lower wall section 374 are arc sections that are formed around the lateral axis 311 and are concentric with an axle 332 that is disposed in the first chamber 331. A second open side portion 373 of the first chamber 331 fluidly couples to the second chamber 341 and a first, opposed open side portion 371 provides the fluidic outlet 318 from the first chamber 331 into the passenger compartment. The axle 332 is disposed on bearings located at lateral ends of the first chamber 331 and at suitable locations along the first chamber 331. A first vane 330 has one side that attaches to the axle 332 and may be a flat, rectangularly-shaped element that is disposed to rotate with the axle 332 about the lateral axis 311. A first gear element 334 couples to the axle 332 and rotates therewith.

The operator-directed slider mechanism 320 includes a sliding gear element 338 and a slider portion 339 that protrudes from the first open side portion 371 of the first chamber 331 into the passenger compartment. The slider mechanism 320 mounts onto a slider axle 335 that is oriented parallel with the axle 332. The slider axle 335 is disposed onto an elevation arm 336 that couples to a longitudinal arm 324, and the sliding gear element 338 meshingly engages the first gear element 334 to rotate in concert. As such, an upward rotation of the slider mechanism 320 causes a corresponding upward rotation of the first vane 330, and a downward rotation of the slider mechanism 320 causes a corresponding downward rotation of the first vane 330.

Various orientations of the slider mechanism 320 and corresponding first vane 330 are shown, including a neutral up/down slider orientation 320D and corresponding neutral first vane position 330D, a lower limit up/down slider orientation 320E and corresponding lower limit first vane position 330E, and an upper limit up/down slider orientation 320F and corresponding upper limit first vane position 330F. The orientations of the slider mechanism 320 and the corresponding first vane 330 direct airflow through the air vent 310 to the fluidic outlet 318. As shown, one such airflow path 317F is shown, indicating an upward airflow when the slider mechanism 320 is in the upper limit up/down slider orientation 320F with the corresponding upper limit first vane position 330F. Slot 322 is formed in the upper wall section 372 and runs parallel with the lateral axis 311, and has a first, leftward end 322B, a neutral position 322A and a second, rightward end 322C. A pin 321 protrudes from a bottom portion of the longitudinal arm 324 and runs in the slot 322. The longitudinal arm 324 couples to a lateral arm 344 that is located adjacent to the second chamber 341. The lateral arm 344 includes one or a plurality of slots 348 that are oriented along the lateral axis 311 and disposed around pins 346 protruding from the housing 315 of the air vent 310. The lateral arm 344 includes a plurality of gear teeth 345. Slot 322 is oriented parallel to the plurality of slots 348.

The plurality of second airflow control vanes 340 may be rectangularly-shaped elements that are disposed in the second chamber 341 to rotate about an axis 347 that is preferably parallel with the elevation axis 313. Each of the second airflow control vanes 340 couples to a laterally-oriented gear element 342. Each of the second airflow control vanes 340 rotates about its corresponding axis 347. Each of the gear elements 342 meshingly engage the teeth 345 of the lateral arm 344 in a rack-and-pinion configuration or another suitable configuration, providing a reverse mechanism so that the second airflow control vanes 340 direct airflow out of the air vent coincident with a direction of the slider mechanism 320.

The operator-directed slider mechanism 320 is moveable along the lateral axis 311, including a neutral orientation 320A, a leftward orientation 320B and a rightward orientation 320C. When the slider mechanism 320 is at the neutral orientation 320A, the teeth 345 of the lateral arm 334 interact with the gear elements 342 to rotate each of the second airflow control vanes 340 to a neutral position 340A. When the slider mechanism 320 is at the leftward orientation 320B, the teeth 345 of the lateral arm 344 interact with the gear elements 342 to rotate each of the second airflow control vanes 340 to a leftward position 340B, thus directing airflow leftwardly through the air vent 310. When the slider mechanism 320 is at the rightward orientation 320C, the teeth 345 of the lateral arm 344 interact with the gear elements 342 to rotate each of the second airflow control vanes 340 to a rightward position 340C, thus directing airflow rightwardly through the air vent 310. As such, the unitary slider mechanism 320 can be employed to direct airflow out of the air vent 310 in both the lateral direction and in the elevation direction.

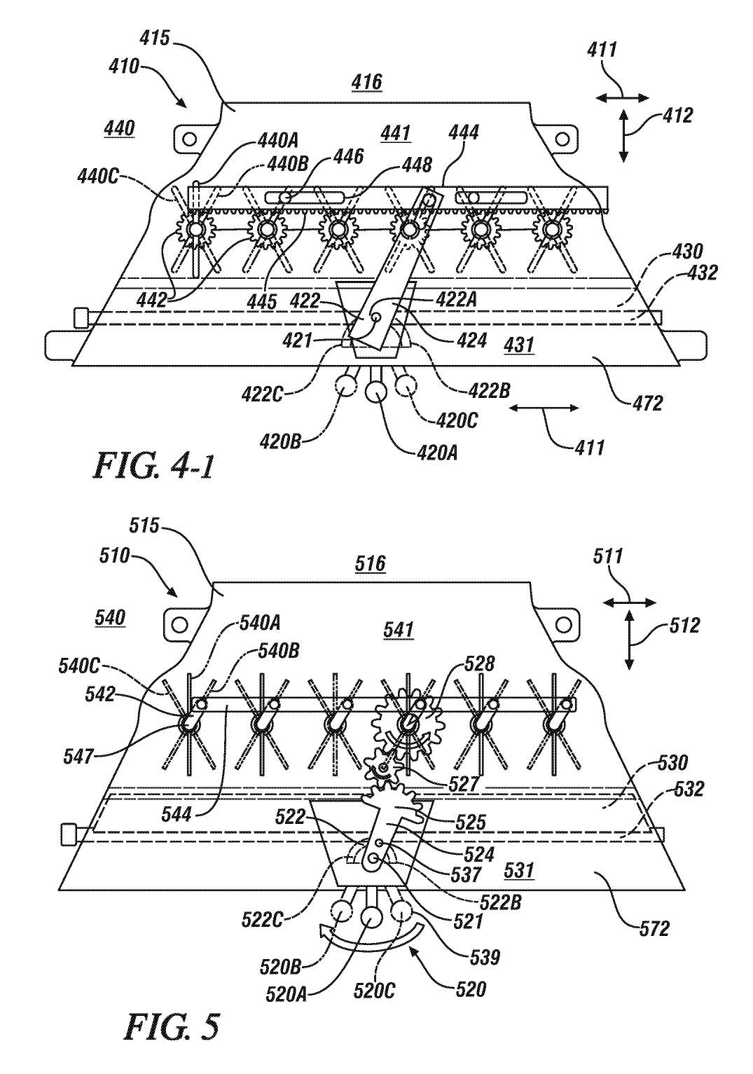

FIGS. 4-1 and 4-2 show a partial cut-away top view and side view, respectively, of an embodiment of a high aspect ratio air vent 410 for an HVAC system that employs a single, unitary operator-directed device 420 for controlling positions of a first airflow control vane 430 and a plurality of second airflow control vanes 440, wherein the operator-directed device 420 may be employed to adjust the position of the first airflow control vane 430 independently from adjusting the positions of the second airflow control vanes 440. The first airflow control vane 430 directs the airflow in a direction that is orthogonal to the airflow directed by the second airflow control vanes 440. In this embodiment, the operator-directed device 420 is a joystick. The top view in FIG. 4-1 is described in context of a lateral axis 411 and a longitudinal axis 412, and the side view of FIG. 4-2 is described in context of the longitudinal axis 412 and an elevation axis 413. The lateral axis 411, longitudinal axis 412 and elevation axis 413 are nominal axes that may relate to corresponding axes in a vehicle, e.g., the vehicle 20 described with reference to FIG. 1.

The air vent 410 may be assembled into a unitary device for assembly into a passenger compartment of the vehicle 20, and includes a housing 415 that is formed to include a first chamber 431 and a second chamber 441. The second chamber 441 is in fluidic communication with the first chamber 431, and airflow received at a fluidic inlet 416 to the air vent 410 passes through the second chamber 441 to the first chamber 431 and then to the fluidic outlet 418 into the passenger compartment. The first chamber 431 is substantially tubular-shaped with a longitudinal axis that is parallel to the lateral axis 411, and includes a non-linear upper wall section 472 and a non-linear lower wall section 474. The non-linear upper wall section 472 and non-linear lower wall section 474 are arc sections that are formed around the lateral axis 411 and are concentric with an axle 432 that is disposed in the first chamber 431. A second open side portion 473 of the first chamber 431 fluidly couples to the second chamber 441 and a first, opposed open side portion 471 provides a fluidic outlet 418 from the first chamber 431 into the passenger compartment. The axle 432 is disposed on bearings located at lateral ends of the first chamber 431 and at suitable locations along the first chamber 431. A first vane 430 has one side that attaches to the axle 432 and may be a flat, rectangularly-shaped element that is disposed to rotate with the axle 432 about the lateral axis 411. A first gear element 434 couples to the axle 432 and rotates therewith.

The operator-directed joystick device 420 includes an elevation pivot point 437 including a gear element portion 438 and an input device 439 that protrudes from the first open side portion 471 of the first chamber 431 into the passenger compartment. The joystick 420 mounts onto the elevation pivot point 437 including axle 435 that is oriented parallel with the axle 432. The axle 435 is disposed onto an elevation arm 436 that couples to a longitudinal arm 424, and the gear element portion 438 meshingly engages the first gear element 434 to rotate in concert. As such, an upward rotation of the joystick 420 causes a corresponding upward rotation of the first vane 430, and a downward rotation of the joystick 420 causes a corresponding downward rotation of the first vane 430. Various orientations of the joystick 420 and corresponding first vane 430 are shown, including a neutral up/down orientation 420D and corresponding neutral first vane position 430D, a lower limit up/down orientation 420E and corresponding lower limit first vane position 430E, and an upper limit up/down orientation 420F and corresponding upper limit first vane position 430F. The orientations of the joystick 420 and the corresponding first vane 430 direct airflow through the air vent 410 to the fluidic outlet 418. As shown, one such airflow path 417F is shown, indicating an upward airflow when the joystick 420 is in the upper limit up/down orientation 420F with the corresponding upper limit first vane position 430F.

An arced slot 422 is formed in the upper wall section 472, and has a first, leftward end 422B, a neutral position 422A and a second, rightward end 422C. The joystick includes a lateral pivot point 421 that is associated with the arced slot 422. The longitudinal arm 424 runs in the arced slot 422. The longitudinal arm 424 couples to a lateral arm 444 that is located adjacent to the second chamber 441. The lateral arm 444 includes one or a plurality of slots 448 that are oriented along the lateral axis 411 and disposed around pins 446 protruding from the housing 415 of the air vent 410. The lateral arm 444 includes a plurality of gear teeth 445. The plurality of second airflow control vanes 440 may be rectangularly-shaped elements that are disposed in the second chamber 441 to rotate about an axis 447 that is preferably parallel with the elevation axis 413. Each of the second airflow control vanes 440 couples to a laterally-oriented gear element 442. Each of the second airflow control vanes 440 rotates about its corresponding axis 447. Each of the gear elements 442 meshingly engage the teeth 445 of the lateral arm 444 in a rack-and-pinion configuration or another suitable configuration, providing a reverse mechanism so that the second airflow control vanes 440 direct airflow out of the air vent coincident with a direction of the joystick 420.

The operator-directed joystick 420 rotates about the lateral pivot point 421, and includes a neutral orientation 420A, a leftward orientation 420B and a rightward orientation 420C. When the joystick 420 is at the neutral orientation 420A, the teeth 445 of the lateral arm 444 interact with the gear elements 442 to rotate each of the second airflow control vanes 440 to a neutral position 440A. When the joystick 420 is at the leftward orientation 420B, the teeth 445 of the lateral arm 444 interact with the gear elements 442 to rotate each of the second airflow control vanes 440 to a leftward position 440B, thus directing airflow leftwardly through the air vent 410. When the joystick 420 is at the rightward orientation 420C, the teeth 445 of the lateral arm 444 interact with the gear elements 442 to rotate each of the second airflow control vanes 440 to a rightward position 440C, thus directing airflow rightwardly through the air vent 410. As such, the unitary joystick 420 can be employed to direct airflow out of the air vent 410 in both the lateral direction and in the elevation direction.

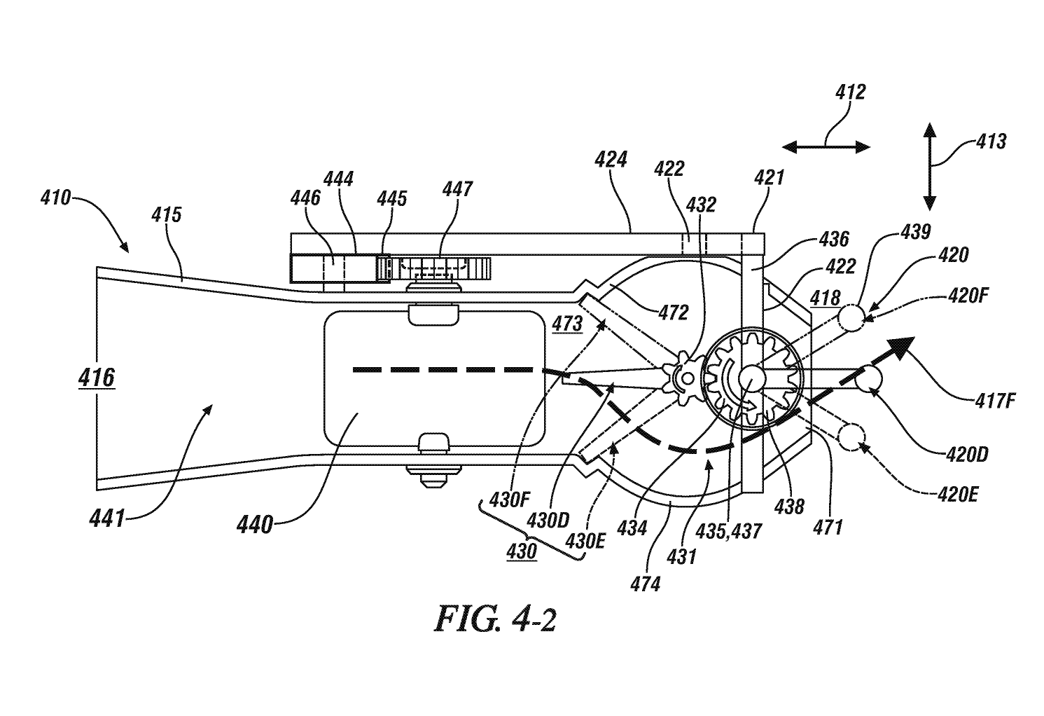

FIG. 5 shows a partial cut-away top view of an embodiment of a high aspect ratio air vent 510 for an HVAC system that employs a single, unitary operator-directed device 520 for controlling positions of a first airflow control vane 530 and a plurality of second airflow control vanes 540, wherein the operator-directed device 520 may be employed to adjust the position of the first airflow control vane 530 independently from adjusting the positions of the second airflow control vanes 540. The first airflow control vane 530 directs the airflow in a direction that is orthogonal to the airflow directed by the second airflow control vanes 540. In this embodiment, the operator-directed device 520 is a joystick, and is analogous the joystick 420 described with reference to FIG. 4. The top view in FIG. 5 is described in context of a lateral axis 511 and a longitudinal axis 512, which are nominal axes that may relate to corresponding axes in a vehicle, e.g., the vehicle 20 described with reference to FIG. 1.

The air vent 510 may be assembled into a unitary device for assembly into a passenger compartment of the vehicle 20, and includes a housing 515 that is formed to include a first chamber 531 and a second chamber 541. The second chamber 541 is in fluidic communication with the first chamber 331, and airflow received at a fluidic inlet 516 to the air vent 510 passes through the second chamber 541 to the first chamber 531 and then to the fluidic outlet 518 into the passenger compartment. The first chamber 531 is substantially tubular-shaped with a longitudinal axis that is parallel to the lateral axis 511, and includes a non-linear upper wall section 572 and a non-linear lower wall section 574. The non-linear upper wall section 572 and non-linear lower wall section 574 are arc sections that are formed around the lateral axis 511 and are concentric with an axle 532 that is disposed in the first chamber 531. The axle 532 is disposed on bearings located at lateral ends of the first chamber 531 and at suitable locations along the first chamber 531.

A first vane 530 has one side that attaches to the axle 532 and may be a flat, rectangularly-shaped element that is disposed to rotate with the axle 532 about the lateral axis 511. The operator-directed joystick 520 includes an elevation pivot point (not shown) and an input device 539 that protrudes from the first chamber 531 into the passenger compartment. An upward rotation of the joystick 520 causes a corresponding upward rotation of the first vane 530, and a downward rotation of the joystick 520 causes a corresponding downward rotation of the first vane 530.

An arced slot 522 is formed in the upper wall section 572, and has a first end 522B, a neutral position (not shown) and a second end 522C. The joystick includes a lateral pivot point 521 that is associated with the arced slot 522. A longitudinal arm 524 runs in the arced slot 522. A distal end of the longitudinal arm 524 includes a partial gear segment 525 that meshingly engages an intermediate gear 527 that meshingly engages a third gear 528 that couples to a lateral arm 544 via a pin 537. The lateral arm 544 couples to each of the second airflow control vanes 540, preferably via a control arm 542. The plurality of second airflow control vanes 540 may be rectangularly-shaped elements that are disposed in the second chamber 541 to rotate about an axis 547. The intermediate gear 527, third gear 528 and lateral arm 544 provide a reverse mechanism so that the second airflow control vanes 540 direct airflow out of the air vent coincident with an orientation of the joystick 520.

The operator-directed joystick 520 rotates about the lateral pivot point 521, and includes a neutral orientation 520A, a leftward orientation 520B and a rightward orientation 520C. When the joystick 520 is at the neutral orientation 520A, the second airflow control vanes 540 are located at a neutral position 540A. When the joystick 520 is at the leftward orientation 520B, the second airflow control vanes 540 are located at a leftward position 540B, thus directing airflow leftwardly through the air vent 510. When the joystick 520 is at the rightward orientation 520C, the second airflow control vanes 540 are located at a rightward position 540C, thus directing airflow rightwardly through the air vent 510. As such, the unitary joystick 520 can be employed to direct airflow out of the air vent 510 in both the lateral direction and in the elevation direction.

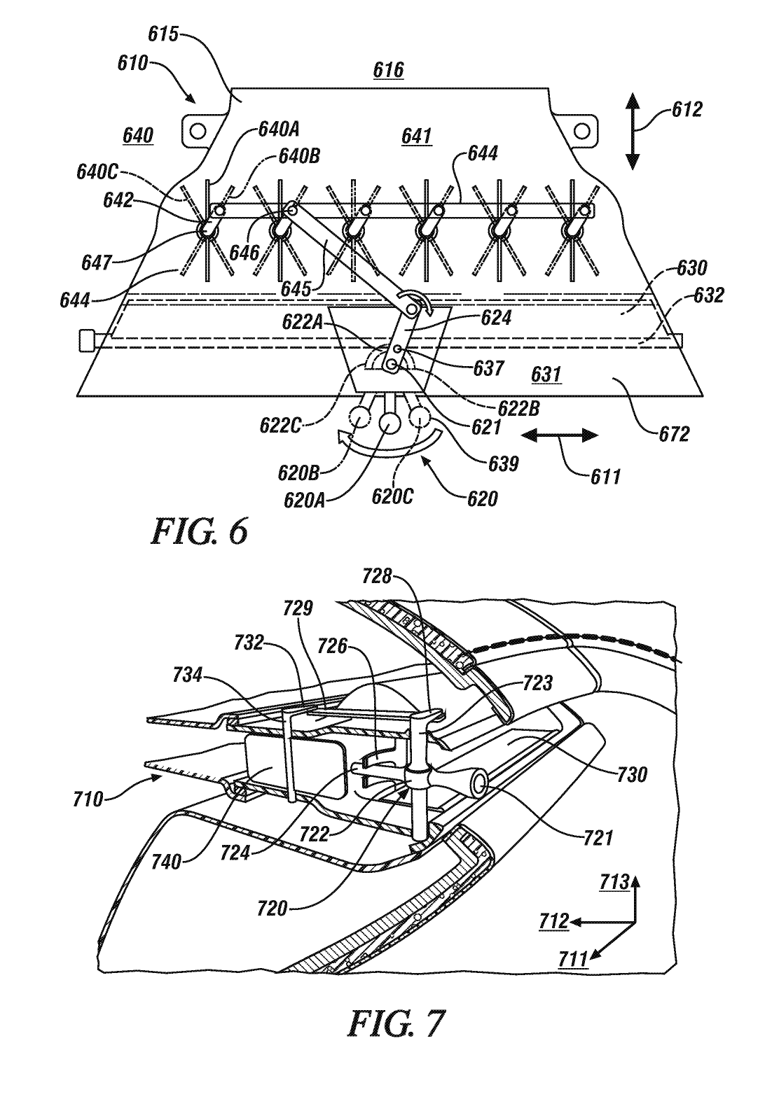

FIG. 6 shows a partial cut-away top view of an embodiment of a high aspect ratio air vent 610 for an HVAC system that employs a single, unitary operator-directed device 620 for controlling positions of a first airflow control vane 630 and a plurality of second airflow control vanes 640, wherein the operator-directed device 620 may be employed to adjust the position of the first airflow control vane 630 independently from adjusting the positions of the second airflow control vanes 640. The first airflow control vane 630 directs the airflow in a direction that is orthogonal to the airflow directed by the second airflow control vanes 640. In this embodiment, the operator-directed device 620 is a joystick, and is analogous the joystick 420 described with reference to FIG. 4. The top view in FIG. 6 is described in context of a lateral axis 611 and a longitudinal axis 612, which are nominal axes that may relate to corresponding axes in a vehicle, e.g., the vehicle 20 described with reference to FIG. 1.

The air vent 610 may be assembled into a unitary device for assembly into a passenger compartment of the vehicle 20, and includes a housing 615 that is formed to include a first chamber 631 and a second chamber 641. The second chamber 641 is in fluidic communication with the first chamber 631, and airflow received at a fluidic inlet 616 to the air vent 610 passes through the second chamber 641 to the first chamber 631 and then to the fluidic outlet 618 into the passenger compartment. The first chamber 631 is substantially tubular-shaped with a longitudinal axis that is parallel to the lateral axis 611, and includes a non-linear upper wall section 672 and a non-linear lower wall section 674. The non-linear upper wall section 672 and non-linear lower wall section 674 are arc sections that are formed around the lateral axis 611 and are concentric with an axle 632 that is disposed in the first chamber 631. The axle 63 is disposed on bearings located at lateral ends of the first chamber 631 and at suitable locations along the first chamber 631. The first vane 630 has one side that attaches to the axle 632 and may be a flat, rectangularly-shaped element that is disposed to rotate with the axle 632 about the lateral axis 611. The operator-directed joystick 620 includes an elevation pivot point (not shown) and an input device 639 that protrudes from the first chamber 631 into the passenger compartment. An upward rotation of the joystick 620 causes a corresponding upward rotation of the first vane 630, and a downward rotation of the joystick 620 causes a corresponding downward rotation of the first vane 630.

An arced slot 622 is formed in the upper wall section 672, and has a first end 622B, a neutral position 622A and a second end 622C. The joystick 620 includes a lateral pivot point 621 that is associated with the arced slot 622. A longitudinal arm 624 includes runs in the arced slot 622. A distal end of the longitudinal arm 624 pivotably couples to a second arm 645 that pivotably couples to a lateral arm 644 via a pin 646. The lateral arm 644 couples to each of the second airflow control vanes 640, preferably via a control arm 642, thus providing a reverse mechanism so that the second airflow control vanes 640 direct airflow out of the air vent 610 coincident with an orientation of the joystick 620. The plurality of second airflow control vanes 640 may be rectangularly-shaped elements that are disposed in the second chamber 641 to rotate about an axis 647.

The operator-directed joystick device 620 rotates about the lateral pivot point 621, and includes a neutral orientation 620A, a leftward orientation 620B and a rightward orientation 620C. When the joystick device 620 is at the neutral orientation 620A, the second airflow control vanes 640 are located at a neutral position 640A. When the joystick 620 is at the leftward orientation 620B, the second airflow control vanes 640 are located at a leftward position 640B, thus directing airflow leftwardly through the air vent 610. When the joystick 620 is at the rightward orientation 620C, the second airflow control vanes 640 are located at a rightward position 640C, thus directing airflow rightwardly through the air vent 610. As such, the joystick device 620 can be employed to direct airflow out of the air vent 610 in both the lateral direction and in the elevation direction.

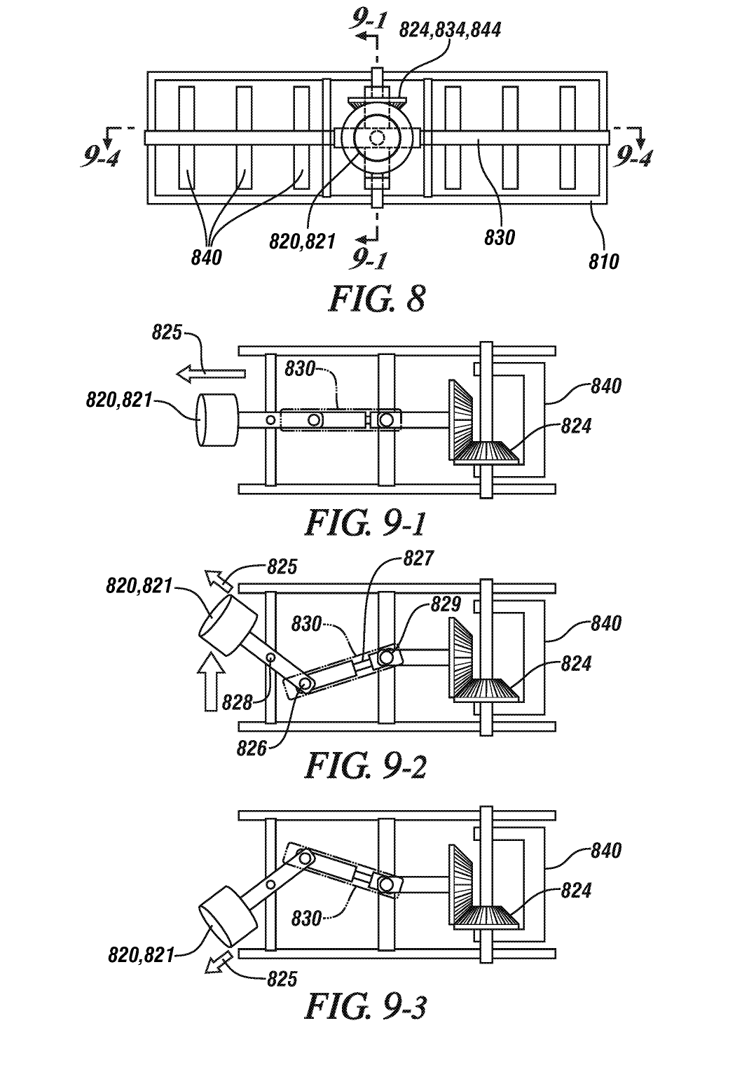

FIG. 7 shows a partial cut-away isometric view of an embodiment of a high aspect ratio air vent 710 for an HVAC system that employs a single, unitary operator-directed device 720 for controlling positions of a first airflow control vane 730 and a plurality of second airflow control vanes 740, a single one of which is shown. The operator-directed device 720 may be employed to adjust the position of the first airflow control vane 730 independently from adjusting the positions of the second airflow control vanes 740. The first airflow control vane 730 directs the airflow in a direction that is orthogonal to the airflow directed by the second airflow control vanes 740. In this embodiment, the operator-directed device 720 is a center pivot joystick. FIG. 7 is described in context of a lateral axis 711, a longitudinal axis 712, and an elevation axis 713, which are nominal axes that may relate to corresponding axes in a vehicle, e.g., the vehicle 20 described with reference to FIG. 1.

The operator-directed joystick device 720 includes an input device 721, a vertical pin 723 and a horizontal pin 724 that couple at a pivot 722. The input device 721 protrudes into the passenger compartment. The pivot 722 is a two-degree of freedom pivot device that includes an up-and-down movement and a left-right movement. The horizontal pin 724 interacts with a fork 726 that couples to the first airflow control vane 730. The vertical pin 723 includes a lever arm 728 that couples via a link 729 to a lever arm 732 connected to a second vertical rotatable pin 734 that connects to the second airflow control vane 740. An upward rotation of the input device 721 causes a corresponding upward rotation of the first vane 730, and a downward rotation of the input device 721 causes a corresponding downward rotation of the first vane 730. A leftward rotation of the input device 721 causes a corresponding leftward movement of the second airflow control vanes 740, and rightward rotation of the input device 721 causes a corresponding rightward movement of the second airflow control vanes 740.

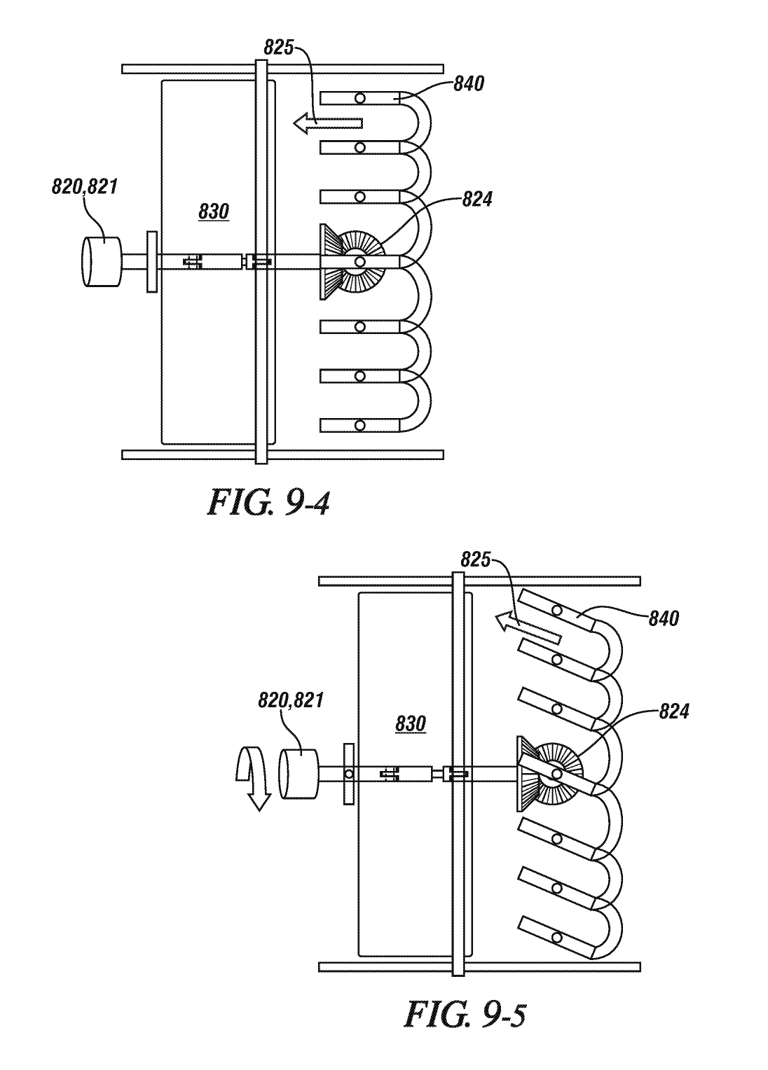

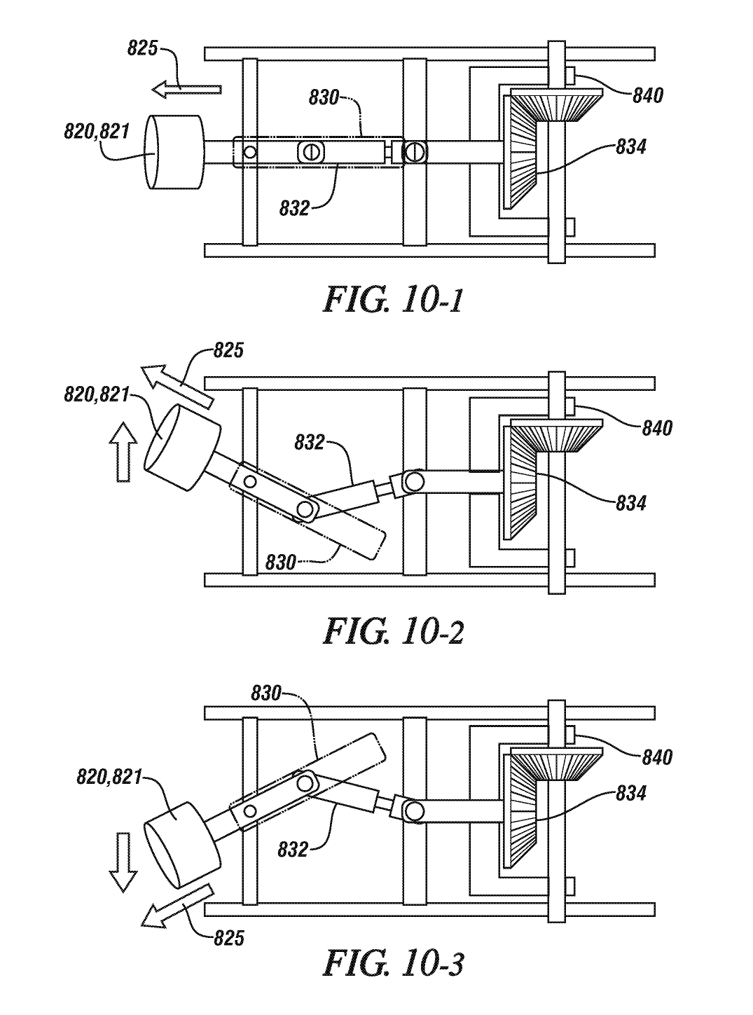

FIG. 8 schematically show a front view of an embodiment of a high aspect ratio air vent 810 for an HVAC system that employs a single, unitary operator-directed device 820 for controlling positions of a first airflow control vane 830 and a plurality of second airflow control vanes 840. The first airflow control vane 830 is arranged horizontally as shown and the second airflow control vanes 840 are arranged vertically as shown, although the disclosure is not so limited. The operator-directed device 820 may be employed to adjust the position of the first airflow control vane 830 independently from adjusting the positions of the second airflow control vanes 840. In this embodiment, the operator-directed device 820 includes a rotatable thumbwheel 821 that is capable of being translated upwardly or downwardly and also capable of being rotated. The thumbwheel 821 couples via suitable mechanical linkages 826, telescoping shafts 827, ball joints and fixed pivot points 828, 829 to the first airflow control vane 830, and further couples via suitable mechanical linkages, ball joints, telescoping shafts and fixed pivot points to a gear arrangement that couples to the second airflow control vanes 840. The gear arrangement may include one of a first bevel gear 824 (FIGS. 9-1 through 9-5), a second bevel gear 834 (FIGS. 10-1 through 10-5), a rack and pinion gear 844 (FIGS. 11-1 through 11-3), or another suitable gear arrangement. The thumbwheel 821 protrudes into the passenger compartment. Upward or downward movement of the thumbwheel 821 raises or lowers the first airflow control vanes 830, and clockwise or counter-clockwise rotation of the thumbwheel 821 rotates the second airflow control vanes 840 in a corresponding direction via the bevel gear arrangement 824. Sections A-A and B-B are identified for reference to this view in each of the embodiments depicted with reference to FIGS. 9-11.

FIGS. 9-1 through 9-5 schematically show one embodiment of the air vent 810 that employs the thumbwheel 821 for controlling positions of first airflow control vane 830 and a plurality of second airflow control vanes 840 employing the first bevel gear arrangement 824 to adjust the second airflow control vanes 840. FIGS. 9-1, 9-2 and 9-3 each show the side view A-A of the air vent 810, including the airflow path 825 being straight-ward when the thumbwheel 821 is in a neutral elevation location (FIG. 9-1), the airflow path 825 being upward when the thumbwheel 821 is oriented upwardly (FIG. 9-2), and the airflow path 825 being downward when the thumbwheel 821 is oriented downwardly (FIG. 9-3). FIGS. 9-4 and 9-5 each show the top view B-B of the air vent 810 including the airflow path 825 being straight-ward when the thumbwheel 821 is in a neutral rotation (FIG. 9-4), and the air vent 810 including the airflow path 825 being leftward when the thumbwheel 821 is rotated in a clockwise rotation (FIG. 9-5).

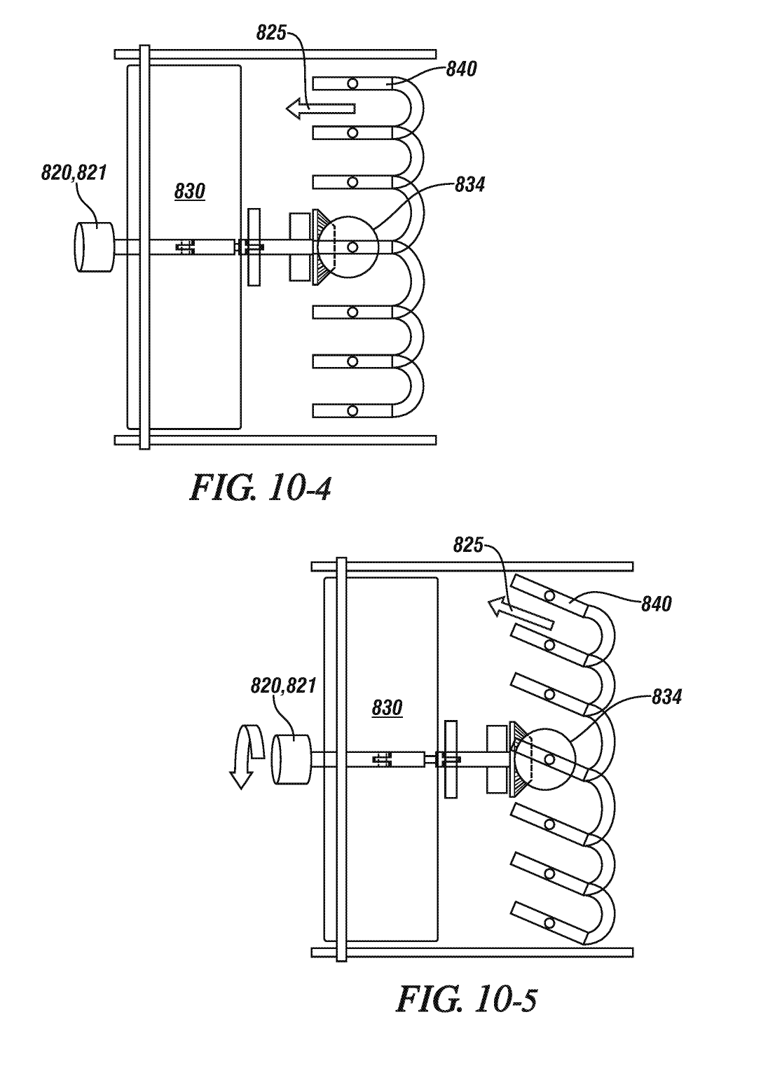

FIGS. 10-1 through 10-5 schematically show another embodiment of the air vent 810 that employs the thumbwheel 821 for controlling positions of first airflow control vane 830 and a plurality of second airflow control vanes 840 employing the second bevel gear arrangement 834 to adjust the second airflow control vanes 840. The thumbwheel 821 couples via a flexible drive shaft 832 to the first airflow control vanes 830 and the second airflow control vanes 840. The flexible drive shaft 832, also referred to as a Cardan shaft, includes mechanical linkages, universal joints and telescoping shafts. FIGS. 10-1, 10-2 and 10-3 each show the side view A-A of the air vent 810, including the airflow path 825 being straight-ward when the thumbwheel 821 is in a neutral elevation location (FIG. 10-1), the airflow path 825 being upward when the thumbwheel 821 is positioned upwardly (FIG. 10-2), and the airflow path 825 being downward when the thumbwheel 821 is oriented downwardly (FIG. 10-3). FIGS. 10-4 and 10-5 each show the top view B-B of the air vent 810 including the airflow path 825 being straight-ward when the thumbwheel 821 is in a neutral rotation (FIG. 10-4), and the air vent 810 including the airflow path 825 being leftward when the thumbwheel 821 is rotated in a counter-clockwise rotation (FIG. 10-5).

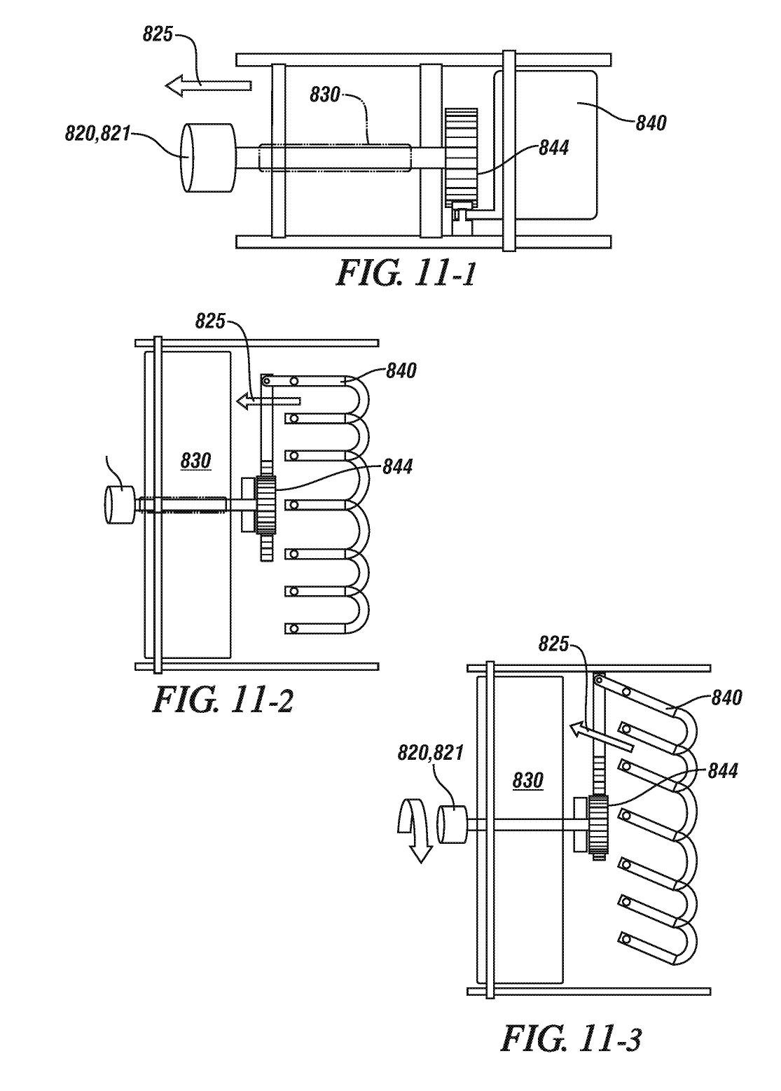

FIGS. 11-1 through 11-3 schematically show one embodiment of the air vent 810 that employs the thumbwheel 821 for controlling positions of first airflow control vane 830 and a plurality of second airflow control vanes 840 employing the rack and pinion gear arrangement 844 to adjust the second airflow control vanes 840. FIG. 11-1 shows the side view A-A of the air vent 810, including the airflow path 825 being straight-ward when the thumbwheel 821 is in a neutral elevation location (FIG. 11-1). FIGS. 11-2 and 11-3 each show the top view B-B of the air vent 810 including the airflow path 825 being straight-ward when the thumbwheel 821 is in a neutral rotation (FIG. 11-2), and the air vent 810 including the airflow path 825 being leftward when the thumbwheel 821 is rotated in a counter-clockwise rotation (FIG. 11-3). In each of the embodiments, the first airflow control vane directs the airflow from the vent in a direction that is orthogonal to the airflow directed by the second airflow control vanes. Furthermore, either or both the first airflow control vane and the second airflow control vanes is capable of completely blocking airflow from the vent.

While the best modes for carrying out the many aspects of the present teachings have been described in detail, those familiar with the art to which these teachings relate will recognize various alternative aspects for practicing the present teachings that are within the scope of the appended claims.

1. An air vent disposed between an air circulation device and an interior space, wherein the air circulation device is capable of creating an airflow, the air vent comprising:
a housing defining a first chamber in fluidic communication with a second chamber, wherein the first chamber includes a fluidic inlet in fluidic communication with the air circulation device and the second chamber includes a fluidic outlet in fluidic communication with the interior space;
a first airflow control vane disposed in the first chamber and configured to direct the airflow from the air circulation device in a first direction;
a second airflow control vane disposed in the second chamber and configured to direct the airflow in a second direction that is orthogonal to the first direction; and
a single operator-directed device operatively coupled to the first airflow control vane and the second airflow control vane, wherein the single operator-directed device is disposed to independently adjust the positions of the first and second airflow control vanes.

2. The air vent of claim 1, wherein the single operator-directed device comprises a slider mechanism having a portion disposed in the interior space, and wherein the single operator-directed device configured to independently adjust the positions of the first and second airflow control vanes comprises the slider mechanism mounted on a slider axle, the slider axle coupled to a rack-and-pinion device coupled to the second airflow control vane and the slider axle coupled to a sliding gear element meshingly engaged to a first gear coupled to the first airflow control valve.

3. The air vent of claim 1, wherein the single operator-directed device comprises a joystick having a portion disposed in the interior space, and wherein the single operator-directed device configured to independently adjust the positions of the first and second airflow control vanes comprises the joystick disposed on the housing at an elevation pivot point and a lateral pivot point, the lateral pivot point coupled to a rack-and-pinion device coupled to the second airflow control vane and the elevation pivot point coupled to a sliding gear element meshingly engaged to a first gear coupled to the first airflow control valve.

4. The air vent of claim 1, wherein the single operator-directed device comprises a joystick having a portion disposed in the interior space, and wherein the single operator-directed device configured to independently adjust the positions of the first and second airflow control vanes comprises the joystick disposed on the housing at an elevation pivot point and a lateral pivot point, the lateral pivot point coupled via a longitudinal arm including a partial gear segment meshingly engaging an intermediate gear meshingly engaging a third gear coupled to the second airflow control vane and the elevation pivot point coupled to a sliding gear element meshingly engaged to a first gear coupled to the first airflow control valve.

5. The air vent of claim 1, wherein the single operator-directed device comprises a joystick having a portion disposed in the interior space, and wherein the single operator-directed device configured to independently adjust the positions of the first and second airflow control vanes comprises the joystick disposed on the housing at an elevation pivot point and a lateral pivot point, the lateral pivot point coupled via a longitudinal arm coupled to a second arm coupled to the second airflow control vane and the elevation pivot point coupled to a sliding gear element meshingly engaged to a first gear coupled to the first airflow control valve.

6. The air vent of claim 1, wherein the single operator-directed device comprises a center pivot joystick having an input device disposed in the interior space, and wherein the single operator-directed device configured to independently adjust the positions of the first and second airflow control vanes comprises the center pivot joystick including a vertical pin and a horizontal pin that couple at a pivot and is disposed in the housing, the pivot being a two-degree of freedom pivot device that includes an up-and-down movement and a left-right movement, the vertical pin including a lever arm coupled via a link to a lever arm connected to a second vertical rotatable pin coupled to the second airflow control vane and the horizontal pin coupled via a fork coupled to the first airflow control valve.

7. The air vent of claim 1, wherein the single operator-directed device comprises a rotatable thumbwheel having an input device disposed in the interior space, and wherein the single operator-directed device configured to independently adjust the positions of the first and second airflow control vanes comprises the rotatable thumbwheel coupled via a mechanical linkage, telescoping shaft, ball joint and a first fixed pivot point to the first airflow control vane, and coupled via a second fixed pivot point to a gear arrangement coupled to the second airflow control vane.

8. The air vent of claim 7, wherein the rotatable thumbwheel coupled via a mechanical linkage, telescoping shaft, ball joint and a first fixed pivot point to the first airflow control vane comprises the rotatable thumbwheel coupled to the first fixed pivot point which is coupled via a Cardan shaft to the second fixed pivot point.

9. The air vent of claim 1, wherein the single operator-directed device comprises a rotatable thumbwheel having an input device disposed in the interior space, and wherein the single operator-directed device configured to independently adjust the positions of the first and second airflow control vanes comprises the rotatable thumbwheel coupled via a mechanical linkage, telescoping shaft, ball joint and a first fixed pivot point to the first airflow control vane, and coupled via a second fixed pivot point to a rack-and-pinion arrangement coupled to the second airflow control vane.

10. The air vent of claim 1, wherein the first chamber is tubular-shaped with a longitudinal axis that is parallel to a lateral axis of the vehicle, including an arc-shaped upper wall section and an arc-shaped lower wall section.

11. The air vent of claim 1, wherein the second chamber is rectangularly-shaped.

12. The air vent of claim 1, wherein the fluidic outlet defining the fluidic opening into the interior space of the vehicle is configured with a rectangular opening defining a length and a height, and wherein an aspect ratio of the length in relation to the height is a high aspect ratio.

13. An air vent for a vehicle, comprising:
a housing extending between a fluidic inlet and a fluidic outlet, the fluidic inlet disposed to receive airflow from an air circulation device and the fluidic outlet defining a fluidic opening into an interior space of the vehicle;
a first airflow control vane configured to control airflow from the air vent in a first direction;
a plurality of second airflow control vanes arranged to control airflow from the air vent in a second direction orthogonal to the first direction; and
a single operator-directed device operatively coupled to the first airflow control vane and the second airflow control vane, wherein the single operator-directed device is disposed to independently adjust the positions of the first and second airflow control vanes;
wherein direction of airflow out of the air vent coincides with an orientation of the single operator-directed device.

14. The air vent of claim 13, wherein the single operator-directed device comprises a slider mechanism having a portion disposed in the interior space, and wherein the single operator-directed device configured to independently adjust the positions of the first and second airflow control vanes comprises the slider mechanism mounted on a slider axle, the slider axle coupled to a rack-and-pinion device coupled to the second airflow control vane and the slider axle coupled to a sliding gear element meshingly engaged to a first gear coupled to the first airflow control valve.

15. The air vent of claim 13, wherein the single operator-directed device comprises a joystick having a portion disposed in the interior space, and wherein the single operator-directed device configured to independently adjust the positions of the first and second airflow control vanes comprises the joystick disposed on the housing at an elevation pivot point and a lateral pivot point, the lateral pivot point coupled to a rack-and-pinion device coupled to the second airflow control vanes and the elevation pivot point coupled to a sliding gear element meshingly engaged to a first gear coupled to the first airflow control valve.

16. The air vent of claim 13, wherein the single operator-directed device comprises a joystick having a portion disposed in the interior space, and wherein the single operator-directed device configured to independently adjust the positions of the first and second airflow control vanes comprises the joystick disposed on the housing at an elevation pivot point and a lateral pivot point, the lateral pivot point coupled via a longitudinal arm including a partial gear segment meshingly engaging an intermediate gear meshingly engaging a third gear coupled to the second airflow control vanes and the elevation pivot point coupled to a sliding gear element meshingly engaged to a first gear coupled to the first airflow control valve.

17. The air vent of claim 13, wherein the single operator-directed device comprises a joystick having a portion disposed in the interior space, and wherein the single operator-directed device configured to independently adjust the positions of the first and second airflow control vanes comprises the joystick disposed on the housing at an elevation pivot point and a lateral pivot point, the lateral pivot point coupled via a longitudinal arm coupled to a second arm coupled to the second airflow control vanes and the elevation pivot point coupled to a sliding gear element meshingly engaged to a first gear coupled to the first airflow control valve.

18. The air vent of claim 13, wherein the single operator-directed device comprises a center pivot joystick having an input device disposed in the interior space, and wherein the single operator-directed device configured to independently adjust the positions of the first and second airflow control vanes comprises the center pivot joystick including a vertical pin and a horizontal pin that couple at a pivot and is disposed in the housing, the pivot being a two-degree of freedom pivot device that includes an up-and-down movement and a left-right movement, the vertical pin including a lever arm coupled via a link to a lever arm connected to a second vertical rotatable pin coupled to the second airflow control vanes and the horizontal pin coupled via a fork coupled to the first airflow control valve.

19. The air vent of claim 13, wherein the single operator-directed device comprises a rotatable thumbwheel having an input device disposed in the interior space, and wherein the single operator-directed device configured to independently adjust the positions of the first and second airflow control vanes comprises the rotatable thumbwheel coupled via a mechanical linkage, telescoping shaft, ball joint and a first fixed pivot point to the first airflow control vane, and coupled via a second fixed pivot point to a gear arrangement coupled to the second airflow control vanes.

20. The air vent of claim 13, wherein the single operator-directed device comprises a rotatable thumbwheel having an input device disposed in the interior space, and wherein the single operator-directed device configured to independently adjust the positions of the first and second airflow control vanes comprises the rotatable thumbwheel coupled via a mechanical linkage, telescoping shaft, ball joint and a first fixed pivot point to the first airflow control vane, and coupled via a second fixed pivot point to a rack-and-pinion arrangement coupled to the second airflow control vanes.
